(19) United States
(12) Patent Application Publication
(10) Pub. No.: US 2025/0376564 A1
(43) Pub. Date: Dec. 11, 2025

(54) METHOD FOR OBTAINING A LIGNOCELLULOSIC COMPOSITE MATERIAL AND COMPOSITE MATERIAL OBTAINED THEREOF

(71) Applicant: SAS WOODOO, Paris (FR)

(72) Inventors: Timothée BOITOUZET, Paris (FR); Alexandre GILET, Paris (FR); Achille ARLIGUIE, Paris (FR)

(21) Appl. No.: 19/049,689

(22) Filed: Feb. 10, 2025

Related U.S. Application Data
(63) Continuation of application No. PCT/FR2023/051267, filed on Aug. 11, 2023.

(30) Foreign Application Priority Data
Aug. 11, 2022 (FR) 2208245

(51) Int. Cl. C08H 8/00; B27K 3/08; B27K 3/34

(52) U.S. Cl. CPC C08H 8/00; B27K 3/08; B27K 3/34

(57) ABSTRACT

The present invention relates to a method for obtaining a lignocellulosic composite material, a lignocellulosic composite material capable of being obtained by this method, and the use of this lignocellulosic composite material.

### CROSS-REFERENCE

This application is a continuation of International Patent Application No. PCT/FR2023/051267, filed Aug. 11, 2023, which claims priority to French Patent Application No. 2208245, filed Aug. 11, 2022, which applications are incorporated herein by reference in their entirety for all purposes.

### FIELD OF THE INVENTION

The present invention relates to a method for obtaining a lignocellulosic composite material, a lignocellulosic composite material to be obtained by this method and the use of this lignocellulosic composite material.

### BACKGROUND

The flexible materials used at the present time result from highly polluting chemical and physical methods. The flexible plastics industry is mainly based on petroleum resources such as polyvinyl chloride (PVC) or polyesters and the textile and leather industry on transformation methods that may be lengthy and polluting such as tanning in baths of solutions of compounds based on chromium. The main quality of these materials is to have biaxial flexibility, i.e., being able to be deformed in two axes simultaneously.

Wood is a more ecological alternative to these materials. However, wood is a naturally anisotropic material, i.e., the mechanical properties thereof are dependent on the direction in which the material is considered. In particular, wood is not naturally flexible because of its structure. Thus, a thin sheet of wood (veneer) has better bending properties in the tangential direction (parallel to the fibres, at) 90° than in the longitudinal or axial direction (direction of the fibres, at) 0°. These properties do however remain limited, the radii of deformation accepted by the sheet of wood being relative to its thickness. This is in particular due to the fact that there is no possible transfer of stress in the lignocellulosic structure.

Non-permanent suppling of wood is known to persons skilled in the art. For example, methods for suppling by steam or by ammonia make it possible to give to the wood angles that are not possible under ambient conditions of humidity and/or temperature. The compounds introduced fulfil the role of a plasticisation of the components of the wood. However, the flexibility provided is not permanent, the wood regaining its initial rigidity once the steam has been extracted from the wood.

It is also usual to obtain a cut of wood is fine as possible in order to reduce the radius of curvature accepted before rupture, these two parameters being independent. Cuts on the surface of the wood by various methods have also been made to make it possible to increase flexibility. However, the wood thus obtained has marks due to the cuts made, which changes the natural appearance of the wood.

Another method is that of calendering the wood, i.e., passing it between two rollers to crush it. This method nevertheless requires complying with specific humidity and temperature conditions so that this can supple the wood, thus weakening it. Another option relates to the use of calenders having a particular geometry (notched for example) having an impact on the final appearance of the wood and weakening it.

Impregnating compounds in the wood is also known to provide a certain flexibility but this has an impact only on flexibility in tangential stressing (perpendicular to the fibres).

Thus, at the present time, there is no method for obtaining a flexible lignocellulosic material, i.e., one having permanent biaxial flexibility at ambient temperature while preserving a natural appearance and feel.

Surprisingly and unexpectedly, the inventors found that the method according to the invention made it possible to obtain a lignocellulosic composite material having improved biaxial flexibility compared with the starting material and permanent at ambient temperature while preserving a natural appearance and feel.

### SUMMARY

A first object of the invention relates to a method for obtaining a lignocellulosic composite material comprising the following steps:
a step (1) of partial hydration and/or partial dissolution of the cellulose and/or of the hemicelluloses present in the lignocellulosic material,
a step (2) of impregnating, with at least one filling compound, the lignocellulosic material resulting from step (1), and
a step (3) of using the lignocellulosic material resulting from step (2),
said method comprising a step of in-situ regeneration of the cellulose and/or of the hemicelluloses at the end of step (1) and/or during the impregnation step (2).

Another object of the invention is a lignocellulosic composite material to be obtained by the method as defined above.

The invention also relates to the use of the material as defined above, for manufacturing pieces, containers, claddings or surfaces.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 illustrates photographs of the material obtained. This figure shows the biaxial flexibility (hyperbolic paraboloid surfaces-longitudinal flexibility) of the material obtained at the end of the mechanical treatment step of the method of example 1.

FIG. 2 illustrates a diagram presenting the tangential radius of curvature of the material obtained after each step of the method of example 1 compared with the initial material used.

FIG. 3 illustrates a diagram presenting the mechanical properties under traction of the material obtained at the end of the impregnation step of example 1 compared with the initial material used.

### DETAILED DESCRIPTION

A first object of the invention relates to a method for obtaining a lignocellulosic composite material comprising the following steps:
a step (1) of partial hydration and/or partial dissolution of the cellulose and/or of the hemicelluloses present in the lignocellulosic material,
a step (2) of impregnating, with at least one filling compound, the lignocellulosic material resulting from step (1), and
a step (3) of using the lignocellulosic material resulting from step (2),
said method comprising a step of in-situ regeneration of the cellulose and/or of the hemicelluloses at the end of step (1) and/or during the impregnation step (2).

“Comprising the following steps” means here “comprising at least the following steps.”

Thus, the present inventors found surprisingly and unexpectedly that the specific combination of these three steps made it possible to confer specific properties on the composite material while enabling it to keep a natural appearance and feel.

“Partial hydration of the cellulose and/or of the hemicelluloses” preferably means the hydration of at least part of the cellulose and/or of the hemicelluloses present in the lignocellulosic material.

“Partial dissolution of the cellulose and/or of the hemicelluloses” preferably means the dissolution of at least a part of the cellulose and/or of the hemicelluloses present in the lignocellulosic material.

Preferably, “partial dissolution of the cellulose and/or of the hemicelluloses” means a partial solubilisation of the cellulose and/or of the hemicelluloses, i.e., a solubilisation of at least part of the cellulose and/or of the hemicelluloses present in the lignocellulosic material.

Preferably, in the method as defined above:
step (1) is a step of chemical treatment of a lignocellulosic material for partially hydrating and/or dissolving the cellulose and/or the hemicelluloses present in the lignocellulosic material,
step (2) is a step of impregnating, with at least one filling compound, the lignocellulosic material resulting from step (1), and
step (3) is a step of using, by mechanical and/or thermal and/or thermo-hygro-mechanical treatment, preferably by mechanical treatment, the lignocellulosic material resulting from step (2), said method comprising a step of in-situ regeneration of the cellulose and/or of the hemicelluloses at the end of step (1) and/or during the impregnation step (2).

Preferably, in the method as defined above:
step (1) is a step of chemical treatment of a lignocellulosic material by means of at least one solvent selected from non-delivered sizing aqueous solvents, non-derivatising non-aqueous solvents, derivatising solvents, and mixtures thereof, for partially hydrating and/or dissolving the cellulose and/or the hemicelluloses present in the lignocellulosic material,
step (2) is a step of impregnating, with at least one filling compound, the lignocellulosic material resulting from step (1) to plasticise the cellulose and/or the hemicelluloses present in the lignocellulosic material, and
step (3) is a step of using, by mechanical and/or thermal and/or thermo-hygro-mechanical treatment, preferably by mechanical treatment, the lignocellulosic material resulting from step (2) aimed at destructuring the internal structure of the lignocellulosic material,
said method comprising a step of in-situ regeneration of the cellulose and/or of the hemicelluloses at the end of step (1) and/or during the impregnation step (2).

Thus, preferably, during step (1), the lignocellulosic material is treated by means of a treatment agent making it possible to de-structure the lattice of hydrogen bonds present in the cellulose and/or hemicelluloses and to partially dissolve it or them in its or their structure without extracting it (them) from the lignocellulosic material and to act significantly on the other parietal elements such as lignin. Advantageously, this step will make it possible to partially dissolve and/or hydrate the cellulose and/or the hemicelluloses selectively in order to make it possible to expose the microfibrils and/or the nanofibrils of cellulose and/or of the hemicelluloses and therefore to make them more accessible. Once exposed, these fibrils remain stable as long as their structure is hydrated by the solvent. The partial hydration and/or dissolution of the cellulose and/or of the hemicelluloses also enables the lignocellulosic material to have more affinity with the filling elements used during step (2).

“In-situ regeneration” preferably means the in-situ precipitation of the cellulose and/or of the hemicelluloses present in the lignocellulosic material.

In-situ regeneration of the cellulose and/or of the hemicelluloses may take place following the chemical treatment (1) and/or during the impregnation step (2).

For example, in-situ regeneration of the cellulose and/or of the hemicelluloses may be implemented by neutralising the lignocellulosic material following the chemical treatment (1), for example during the use of basic solutions.

In-situ regeneration of the cellulose and/or hemicelluloses may also be implemented by means of the solvents and/or filling elements used during step (2).

The step of chemical treatment of a lignocellulosic material by means of at least one solvent selected from non-derivatising solvents, non-derivatising non-aqueous solvents, derivatising solvents, and mixtures thereof is preferably a soaking step.

“Non-derivatising solvent” preferably means any solvent allowing hydration or dissolution of a substrate without chemically modifying the structure of the dissolved element.

The non-derivatising aqueous solvent can be selected from, without being limited to, the aqueous solutions of transition-metal Is cuprammonium hydroxide, cupriethylenediamine hydroxide and mixtures thereof, aqueous solutions of ammonium hydroxides such as tetraethylammonium hydroxide, aqueous solutions of alkaline hydroxides such as sodium hydroxide, aqueous solutions of mineral acids such as sulfuric acid, phosphoric acid and mixtures thereof, aqueous solutions of salts such as zinc chloride, lithium chloride, sodium chloride and mixtures thereof, aqueous solutions of urea and derivatives thereof such as thiourea, and mixtures thereof.

The non-derivatising non-aqueous solvent can be selected from, without being limited to, ionic liquids, polyionic liquids, organic solvents such as methylmorpholine oxide, dimethylacetamide, ammonia, dimethylsulfoxide, deep eutectic solvents, and mixtures thereof.

Examples of ionic liquids comprise, but are not limited to, salts consisting of at least one organic cation such as pyridinium, pyridazinium, pyrimidinium, pyrazinium, imidazolium, pyrazolium, oxazolium, triazolium, thiazolium, piperidinium, pyrrolidinium, quinolinium, isoquinolinium or derivatives thereof, and/or at least one organic or inorganic anion such as halides, tetrachloroaluminate, nitrates, hexafluorophosphate, tetrafluoroborate, sulphonates, sulphates, thiocyanates, dicyanamidide, carboxylates and derivatives thereof, and mixtures thereof.

Examples of pyridinium salts comprise, but are not limited to, pyridinium ethyl chloride.

Examples of polyionic liquids comprise, but are not limited to, polymers consisting of a concatenation of organic cations such as pyridinium, pyridazinium, pyrimidinium, pyrazinium, imidazolium, pyrazolium, oxazolium, triazolium, thiazolium, piperidinium, pyrrolidinium, quinolinium, isoquinolinium or derivatives thereof, forming salts with organic or inorganic anion such as halides, tetrachloroaluminate, nitrates, hexafluorophosphate, tetrafluoroborate, sulfonates, sulfates, thiocyanates, dicyanamidide, carboxylates and derivatives thereof, and mixtures thereof.

The non-derivatising non-aqueous solvent may be used in combination with salts such as lithium chloride.

Preferably, dimethylacetamide is used in combination with salts such as lithium chloride.

“Derivatising solvent” preferably means solvents in which the hydration or dissolution of a substrate takes place in combination with a covalent derivatising and causes the formation of a derivative of the substrate, for example an ester, an acetal or an ether.

The derivatising solvent can be selected from, without being limited to, acetic acid and derivatives thereof such as trifluoroacetic acid, dichloroacetic acid, and mixtures thereof, formic acid, nitrogen peroxide, dimethylformamide, paraformaldehyde, chlorotrimethylsilane, acetic anhydride and derivatives thereof, nitric acid and derivatives thereof, and mixtures thereof.

Examples of derivatives of acetic anhydride comprise, but are not limited to, trichloroacetic anhydride.

Examples of derivatives of nitric acid comprise, but are not limited to, nitric anhydride.

Examples of mixtures comprise, but are not limited to, a mixture of sodium hydroxide and urea, a mixture of sodium hydroxide and thiourea, a mixture of zinc chloride and lithium chloride, a mixture of dimethylacetamide and lithium chloride, a mixture of ammonia, sodium chloride and dimethylsulfoxide, a mixture of nitrogen peroxide and dimethylformamide, a mixture of sulfuric acid and formic acid, a mixture of paraformaldehyde and dimethylsulfoxide, a mixture of chlorotrimethylsilane and dimethylsulfoxide, and mixtures thereof, preferably a mixture of sodium hydroxide and urea, a mixture of sodium hydroxide and thiourea, and mixtures thereof.

Preferably, the mixture is an aqueous mixture of sodium hydroxide and urea or an aqueous mixture of sodium hydroxide and thiourea.

When the solvent used during the chemical treatment step (1) is an aqueous solvent, the concentration of the species in solution is preferably between 1% and 25%, preferably between 5% and 20% by weight of dry matter with respect to the weight of the solution.

Advantageously, this concentration range makes it possible to sufficiently hydrate or dissolve the cellulose and/or the hemicelluloses without impairing the structure of the lignocellulosic material.

Preferably, during the chemical treatment step (1), the weight ratio of lignocellulosic material with respect to the weight of solvent is between 0.5% and 99%, preferably between 1% and 50%, and even more preferentially between 2% and 25%, preferably between 0.5% and 50%, or even more preferentially between 0.5% and 25%.

Preferably, the solvent used during the chemical treatment step (1) is a non-derivatising aqueous solvent, a non-derivatising non-aqueous solvent, and mixtures thereof, and even more preferentially a non-derivatising aqueous solvent.

Surprisingly and unexpectedly, the present inventors found that non-derivatising aqueous solvents, non-derivatising non-aqueous solvents and mixtures thereof improved the interaction between the lignocellulosic material and the filling element.

The chemical treatment step can be implemented for a period of between 1 minute and 24 hours, preferably between 5 minutes and 15 hours, and more preferentially between 15 minutes and 6 hours.

The treatment step (1) can be followed by an optional washing step with a solvent making it possible to remove the excess of reagents and/or the reaction residues. It may be preferable to keep the lignocellulosic materials obtained at the end of the treatment, without an additional washing step.

Preferably, the solvent used during the optional washing step is water.

The treatment step (1) and/or the optional washing step can be followed by a step of drying the lignocellulosic material. Drying can make it possible to eliminate the solvent used for the chemical treatment step.

Advantageously, the step (1) of chemical treatment of the lignocellulosic material aimed at partially hydrating and/or dissolving the cellulose and/or the hemicelluloses makes it possible to obtain a closer contact between the cellulose and/or the hemicelluloses and the filling element used during step (2).

Advantageously, the impregnation step (2) makes it possible to make the filling element penetrate the cell wall of the lignocellulosic material. The consequence of this is a plasticising of the cellulose and/or of the hemicelluloses at the molecular level. Advantageously, by virtue of this plasticising, at the end of the impregnation step (2), the lignocellulosic material is made flexible in the tangential direction (parallel to the fibres). During the impregnation step (2), the lumens of the lignocellulosic material can be left void or be filled by the filling element or elements.

One or more filling elements can be used during this impregnation step (2). This impregnation step can also be repeated at least once with filling elements of the same nature or of different natures from the first filling element. Successive impregnation steps can supplement the first impregnation by filling for example the lumens and giving other properties to the lignocellulosic material.

“Repeated at least once” preferably means repeated from 1 to 10 times, more preferentially from 1 to 5 times, and even more preferentially from 1 to 3 times.

The impregnation step (2) can be implemented with the filling element alone or via an impregnation carrier such as a solvent affording better diffusion of the filling element in the lignocellulosic material. The solvent used during the impregnation step can be identical to the one used during the chemical treatment step (1) or identical to the one used during the optional washing step.

Preferably, the filling compound is selected for the affinities that it develops with the elements of the lignocellulosic material so as to provide for example an effect of plasticising and/or reinforcing the latter.

Advantageously, the filling compound is a compound that can penetrate the cell walls of the lignocellulosic material and having an affinity with the polymers constituting the lignocellulosic material. Preferably, the filling compound has the most interactions possible with the cellulose and/or the hemicelluloses so as to plasticise it or them and potentially with the other elements constituting the lignocellulosic material such as the lignin, which it can also plasticise. Thus, any compound capable of associating or creating interactions with the elements constituting the cell wall of the lignocellulosic material, in particular the cellulose and/or the hemicelluloses, is preferential.

The filling compound can be selected from polymers, prepolymers, monomers, compounds resulting from hydrolysis of oxyranic compounds such as ethylene glycol, compounds derived from aziridine such as ethanolamine, compounds resulting from the polymerisation of oxyranic compounds such as polyethylene glycol, compounds resulting from the polymerisation of the compounds derived from aziridine such as polyethyleneimine, polyols such as glycerol, carbohydrates such as sorbitol, ionic liquids and polyionic liquids, deep eutectic solvents, natural polymers such as cellulose, starch and/or chitosan, synthetic polymers and monomers thereof such as polyvinyl alcohol or polyurethanes, carboxylic polyacids such as citric acid, and mixtures thereof.

Examples of polymers comprise, but are not limited to, oligomers, polyethers such as polyethylene glycol, aliphatic polyols such as polyvinyl alcohol, polyamines such as polyethyleneimine, polyurethanes, polyesters, and mixtures thereof.

Examples of prepolymers comprise, but are not limited to, diol polyesters, diol polycarbonates, diol polyalkadienes, epoxy resins, prepolymers of urethanes, and mixtures thereof.

Examples of monomers comprise, but are not limited to, oxyranic compounds, aziridinic compounds, methacrylic compounds, acrylic compounds, epoxies, urethanes, and mixtures thereof.

Examples of ionic liquids comprise, but are not limited to, salts consisting of at least one organic cation such as pyridinium, pyridazinium, pyrimidinium, pyrazinium, imidazolium, pyrazolium, oxazolium, triazolium, thiazolium, piperidinium, pyrrolidinium, quinolinium, isoquinolinium or derivatives thereof, and/or at least one organic or inorganic anion such as halides, tetrachloroaluminate, nitrates, hexafluorophosphate, tetrafluoroborate, sulfonates, sulfates, thiocyanates, dicyanamidide, carboxylates or derivatives thereof, and mixtures thereof.

Examples of pyridinium salts comprise, but are not limited to, pyridinium ethyl chloride.

Examples of polyionic liquids comprise, but are not limited to, polymers consisting of a concatenation of organic cations such as pyridinium, pyridazinium, pyrimidinium, pyrazinium, imidazolium, pyrazolium, oxazolium, triazolium, thiazolium, piperidinium, pyrrolidinium, quinolinium, isoquinolinium or derivatives thereof, forming salts with organic or inorganic anion such as halides, tetrachloroaluminate, nitrates, hexafluorophosphate, tetrafluoroborate, sulfonates, sulfates, thiocyanates, dicyanamidide, carboxylates and derivatives thereof, and mixtures thereof.

Examples of deep eutectic solvents comprise, but are not limited to, mixtures of a quaternary ammonium compound with a hydrogen-bond donor compound.

Examples of quaternary ammoniums comprise, but are not limited to, choline chloride, chlorocholine chloride, betaines, ammonium chloride, and mixtures thereof.

Examples of hydrogen-bond donor compounds comprise, but are not limited to, amides such as urea, thiourea, methylurea, dimethylurea, acetamide, and mixtures thereof, carboxylic acids such as malonic acid, malic acid, maleic acid, citric acid, aconitic acid, and mixtures thereof, alcohols such as glycerol, ethylene glycol, polyethylene glycol, and mixtures thereof, carbohydrates such as glucose, fructose, saccharose, cyclodextrins, and mixtures thereof, and mixtures of these.

Examples of derivatives of natural polymers comprise, but are not limited to, methyl cellulose, ethyl cellulose, hydroxypropylcellulose, carboxymethylcellulose, cellulose acetate, cellulose nitrate, hydroxypropylated starch, hydroxyethylated starch, cationic starch, carboxymethylated starch, phosphated starch, acetylated starch, starch octenyl succinate, and mixtures thereof.

The ratio between the filling compound and the lignocellulosic material can vary according to the required properties.

Preferably, the filling compound is present at a concentration of between 1% and 99%, more preferentially between 15% and 75%, and even more preferentially between 20% and 60% by weight with respect to the total weight of the lignocellulosic material.

The impregnation step (2) can be followed by an optional drying step. The drying can be implemented following the impregnation in the case of the use of an impregnation vector and/or to allow polymerisation of the filling compound such as monomers. Drying can also make it possible to prepare the lignocellulosic material for the subsequent steps, such as optional lamination.

Advantageously, at the end of the treatment (1) and impregnation (2) steps, the lignocellulosic material exhibits an improvement in flexibility under tangential stressing.

Advantageously, the mechanical treatment step (3) destructures the structure of the lignocellulosic material and in particular shears the internal structure of the lignocellulosic material in order to supple it in the axial direction (the direction of the fibre). The impregnated filling element and the optional laminated material can make it possible to preserve the integrity of the lignocellulosic material. During this step, the lattice of hydrogen bonds present in the lignocellulosic material can be reorganised with the filling element.

Advantageously, the mechanical treatment step (3) impacts the biaxial flexibility of the material by microcracking of the structure to the mesoscopic scale, and by bringing the filling element and the structure together by creating bonds to the molecular scale.

The mechanical treatment step can be selected from, without being limited to, padding, bending, calendering, rolling, embossing, blistering, emerizing, producing a moiré effect, fulling, sanforising, beating, staking, creasing, and combinations thereof, preferably calendering.

The heat treatment step can comprise the exposure of the material to a temperature of between −50° C. and 250° C.

Preferably, within the meaning of the present invention, the expressions “thermo-hygro-mechanical treatment” and “thermo-hydro-mechanical treatment” will be used in an undifferentiated manner.

“Thermo-hygro-mechanical treatment” or “thermo-hydro-mechanical treatment” preferably means a mechanical treatment of the material under controlled temperature and humidity conditions.

The mechanical and/or thermal and/or thermo-hygro-mechanical treatment step (3), preferably the mechanical treatment step (3), can be implemented before, during or after the optional step of adding additives, before, during or after the optional drying step, before, during or after the optional lamination step and before, during or after the optional finishing step.

The calendering is preferably implemented by means of a belt press. Preferably, the diameter of the rollers of the press is between 50 cm and 10 mm. Preferably, the wood makes between 1 and 500 passes, preferentially between 20 and 450 passes and more preferentially between 50 and 400 passes in the belt press. Preferably, the pressure applied by the jacks of the belt press is between 0 and 20 bar, more preferentially between 1 and 15 bar, and even more preferentially between 2 and 10 bar.

Advantageously, during the method of the present invention, the internal mesoscopic structure of the lignocellulosic material is cracked so as to reduce the natural anisotropy of the lignocellulosic material without this having any consequence on the external appearance thereof. Mechanical treatment allows a more pronounced bringing together of the filling element with the cellulose and/or the hemicelluloses of the lignocellulosic material, which has or have been made more accessible because of the chemical treatment. Advantageously, these two treatments combined result in an increase of the plasticising effect of the filling element on the lignocellulosic material. This double cracking and pressure action thus makes it possible to obtain novel bending properties of the lignocellulosic material.

Preferably, the mechanical and/or thermal and/or thermo-hygro-mechanical treatment step, more preferentially the mechanical treatment step, is distinct from the tests aimed at controlling the mechanical properties of the lignocellulosic composite material able to be obtained by the method as defined above.

An optional drying step can be implemented before, during and/or after one of the steps as defined above, preferably before, during and/or after the partial hydration and/or partial dissolution step (1), before, during and/or after the impregnation step (2) and/or before, during and/or after the use step (3).

Some of the components of the cell wall other than the cellulose and/or the hemicelluloses may be extracted during step (1).

Preferably, the method as defined above furthermore comprises a step of partial delignification of the lignocellulosic material in order to obtain a partially delignified lignocellulosic material.

The quantity of lignin extracted can be between 0.5% and 99%, preferably between 1% and 50%, and even more preferentially between 5% and 45% with respect to the total weight of the lignin present in the lignocellulosic material.

The optional partial delignification step can make it possible to reduce the density of the lignocellulosic material and to extend the range of the lignocellulosic materials that can be used. The reduction in the proportion of lignin can also enable the lignocellulosic material to have more affinity with the subsequent filling elements.

The method as defined above can furthermore comprise at least one step selected from the group consisting of a step of bleaching the lignocellulosic material, a step of partial or total extraction of the extractables and chromophores from the lignocellulosic material, a step of activation of the hydroxyl groups of the lignocellulosic material, a step of substitution of the hydroxyl groups of the lignocellulosic material, a step of oxidation of the lignocellulosic material, a step of reduction of the lignocellulosic material, a step of transformation of the lignocellulosic material such as slitting to reduce the thickness thereof, and combinations thereof.

These steps can for example be implemented before, during or after the treatment step (1), and/or before, during or after the optional washing step (2) after the treatment step (1).

The method as defined above can furthermore comprise an optional step of adding additives to the lignocellulosic material. This step of adding additives can be implemented by impregnation or by coating. This step can be implemented before, during and/or after one of the steps as defined above, preferably before, during and/or after the partial hydration and/or partial dissolution step (1), before, during and/or after the impregnation step (2) and/or before, during and/or after the implementation step (3).

Examples of additives comprise, but are not limited to, fire-retarding agents, colouring agents, cross-linking agents, hydrophobic or impermeabilizing agents, surfactants, and mixtures thereof.

Examples of fire-retarding agents comprise, but are not limited to, halogenated compounds and derivatives thereof, phosphorus compounds and derivatives thereof, metal oxides and derivatives thereof, metal hydroxides and derivatives thereof, compounds based on boron and derivatives thereof, and mixtures thereof.

Examples of halogenated compounds and derivatives thereof comprise, but are not limited to, chlorinated or brominated paraffins, polybromodiphenylethers, hexabromocyclododecane, tetrabromobisphenol A, polybromobiphenyls, decabromodiphenyl ether, and mixtures thereof.

Examples of phosphorus compounds and derivatives thereof comprise, but are not limited to, organic phosphates, inorganic phosphates, inorganic phosphates, and mixtures thereof.

Examples of metal oxides and derivatives thereof comprise, but are not limited to, antimony oxides.

Examples of metal hydroxides and derivatives thereof comprise, but are not limited to, aluminium hydroxide, magnesium hydroxide, and mixtures thereof.

Examples of compounds based on boron and derivatives thereof comprise, but are not limited to, boric acid, zinc borate, and mixtures thereof.

Examples of colouring agents comprise, but are not limited to, organic pigments, inorganic pigments, organic dyes and mixtures thereof.

Examples of organic pigments comprise, but are not limited to, perylene, quinacridones, phthalocyanines, indigo, sepia, carmine, and mixtures thereof.

Examples of inorganic pigments comprise, but are not limited to, metal oxides, cinnabar, ultramarine (Guimet blue), ochre, cobalt blue, titanium white, zinc white, cadmium yellow, and mixtures thereof.

Examples of organic dyes comprise, but are not limited to, azoic dyes, anthraquinonic dyes, triarylmethane dyes, chlorine dyes, polymethine dyes, and mixtures thereof.

Examples of cross-linking agents comprise, but are not limited to, cross-linking agents having a functionality of at least 2 such as polyepoxides, polyacids, alkoxysilanes and mixtures thereof.

Examples of polyepoxides comprise, but are not limited to, diglycidyl ether, ethylene glycol diglycidyl ether, polyethylene glycol diglycidyl ether, bisphenol A diglycidyl ether, diepoxyoctane, diepoxybutane, and mixtures thereof.

Examples of polyacids comprise, but are not limited to, malonic acid, tartaric acid, citric acid, succinic acid, fumaric acid, oxalic acid, isophthalic acid, phosphoric acid, and mixtures thereof.

Examples of alkoxysilanes comprise, but are not limited to, methyltrimethoxysilane, tetraethoxysilane, tetramethoxysilane, phenyltrimethoxysilane, and mixtures thereof.

Examples of hydrophobic or impermeabilizing agents comprise, but are not limited to, fats, oils, waxes, silica particles such as silica nanoparticles, and mixtures thereof.

Examples of surfactants comprise, but are not limited to, penetration agents, solubilizers, wetting agents, dispersants, emulsifiers, and mixtures thereof.

The method as defined above can furthermore comprise a step of laminating a material, preferably a flexible material, on the lignocellulosic material, or a step of laminating said lignocellulosic composite material on itself in order to obtain a reinforced material.

The laminated material can be selected from, without being limited to, a textile, a non-tanned or tanned skin such as leather, rubber, latex, a foam, another composite material different from the composite material obtained, or a mixture thereof.

This lamination step can be implemented following the impregnation step (2) (in the case where the method does not comprise an optional drying step following the impregnation step (2)) or following the optional drying step (in the case where the method comprises an optional drying step following the impregnation step (2)).

During this optional lamination step, the material can be laminated on a flexible element making it possible to keep the flexibility acquired during the impregnation step (2) while affording an improvement to the mechanical strength of the material such as resistance to tearing. However, the lignocellulosic material can be used without an additional lamination step, its strength being able to be sufficient for numerous applications.

This optional lamination may be permanent or temporary depending on whether the reinforcement material must be present or not in the final material or a recycling of the material is envisaged.

This optional lamination can be implemented before or after the optional step of transforming the material such as slitting to reduce the thickness thereof.

Preferably, the glue used during the lamination step does not modify the flexibility of the material and can be used despite the modifications made by the chemical treatment step (1) and the impregnation step (2) with the filling compound.

Examples of glues that can be used during this lamination step comprise, but are not limited to, vinyl glues, acrylic glues, cyanoacrylic glues, neoprene glues, epoxy glues, silicone-based glues, polyurethane-based glues, glues based on natural polymers, heat-activatable films, and mixtures thereof.

The method as defined above can comprise at least one finishing step comprising the coating of one or more faces of the material with a protective agent and/or a step of physical or chemical treatment of one or more faces of the material.

Examples of physical or chemical treatment steps comprise, but are not limited to, a plasma treatment, a corona treatment, reaction of the surface of the material with silanes, and combinations thereof.

Advantageously, the finishing step makes it possible to protect the material by an element enabling it to provide surface properties such as colouring, texture, mechanical strength (resistance to scratches), resistance to UV, hydrophobia (resistance to moisture) and/or fire resistance, preferably colouring, mechanical strength (resistance to scratches), resistance to UV and/or hydrophobia (resistance to moisture). This finishing step can also make it possible to limit exudation of the filling element over time. This step is optional in that the protection can also be afforded by the filling element used during the impregnation step (2). Thus, this finishing step can be implemented during the impregnation step by filling the lumens with a polymer, depositing a varnish, or by coating or by chemical modification of the surface of the lignocellulosic material. For example, to improve the resistance to UV, agents absorbing UV radiation can be added during the optional finishing step and/or antioxidants can be present in the filling element.

Advantageously, the finishing provided preserves the flexibility provided for the material.

Advantageously, following the transformation operations and before or after the application of the finishing, the wood is made sufficiently flexible to undergo transformation operations that are normally not feasible on wood. The material thus obtained can for example be split to fine thicknesses.

Advantageously, the initial architecture of the lignocellulosic material is preserved at the end of the partial hydration and/or partial dissolution step (1), and/or at the end of the impregnation step (2), preferably the initial architecture of the lignocellulosic material is preserved on the mesoscopic scale at the end of the partial hydration and/or partial dissolution step (1), and/or at the end of the impregnation step (2).

Preferably, said lignocellulosic material is wood.

The wood can be green wood, moist wood or dry wood as defined in WO 2017/098149 (A1) or in WO 2018/224598 (A1). For example, the wood may be wood used after storage of a more or less long duration (from a few days to a few years). This wood may have been transformed after felling, i.e., after having been chopped, cut up, planed, freed of its bark, sapwood and heartwood, or be an engineering wood. This may also be an aged wood, i.e., a wood that has served for example as construction wood. This wood may come from various species and varieties such as those defined in WO 2017/098149 (A1) or in WO 2018/224598 (A1). This wood may have undergone physical or chemical treatment.

The lignocellulosic material may for example be in the form of a sheet, a plank, a plate or a veneer of solid wood.

The method of the present invention can be implemented on all cutting orientations of the lignocellulosic material, preferably in the longitudinal, tangential and/or radial direction of the lignocellulosic material.

Advantageously, the method of the present invention is a method for obtaining a lignocellulosic composite material having biaxial flexibility, preferably at ambient temperature, and even more preferentially permanent at ambient temperature.

Advantageously, the method of the present invention is a method for obtaining a lignocellulosic composite material having biaxial flexibility, preferably at ambient temperature, and even more preferentially permanent at ambient temperature, which is improved compared with the starting lignocellulosic material.

The present invention also relates to a lignocellulosic composite material able to be obtained by the method as defined above.

Preferably, said material as defined above has biaxial flexibility.

Preferably, said material as defined above has biaxial flexibility at ambient temperature.

Preferably, said material as defined above has permanent biaxial flexibility at ambient temperature.

Surprisingly and unexpectedly, the present inventors found that the method as defined above made it possible to obtain a lignocellulosic material having permanent biaxial flexibility at ambient temperature. In particular, all of steps (1) to (3) make it possible to eliminate the natural resistance of the lignocellulosic material to folding without loss of mechanical properties and to obtain a lignocellulosic material having a natural appearance and feel. Advantageously, the method according to the present invention is easy to implement.

“Biaxial flexibility” preferably means the maximum deformation that can be given to the material before plastic deformation thereof.

Preferably, the material as defined above has a biaxial radius of curvature of between 0.1 mm and 100 mm, preferably between 0.5 mm and 50 mm, and even more preferentially between 1 mm and 10 mm.

Thus, advantageously, the material as defined above has a radius of curvature very much smaller than that of the initial material, in particular in the longitudinal direction.

Preferably, the material as defined above has a thickness of between 0.1 mm and 10 mm, preferably between 0.25 mm and 5 mm, and even more preferentially between 0.5 mm and 2 mm.

Preferably, the material as defined above has resistance to repeated bending.

Preferably, the material as defined above has a tensile strength identical to or greater than that of the initial lignocellulosic material.

Preferably, the material as defined above has a resistance to rubbing identical to or greater than that of the initial lignocellulosic material.

Preferably, the material as defined above, for example the one obtained at the end of the optional steps such as lamination and/or obtained at the end of successive impregnation steps, has improved tear resistance compared with the initial lignocellulosic material.

Preferably, the material as defined above, for example the one obtained at the end of the finishing step, has improved surface properties compared with the initial lignocellulosic material.

Preferably, the material as defined above can be stitched, an ability to be slit, and an ability to trimmed, unlike natural lignocellulosic material.

The present invention also relates to a lignocellulosic composite material as defined previously per se.

The present invention also relates to the use of the material as defined above for manufacturing pieces, containers, claddings or surfaces.

The material as defined above can in particular be used in industries using flexible elements for cladding, in particular the textile field, or the leather, packaging or automobile field.

### DESCRIPTION OF THE FIGURES

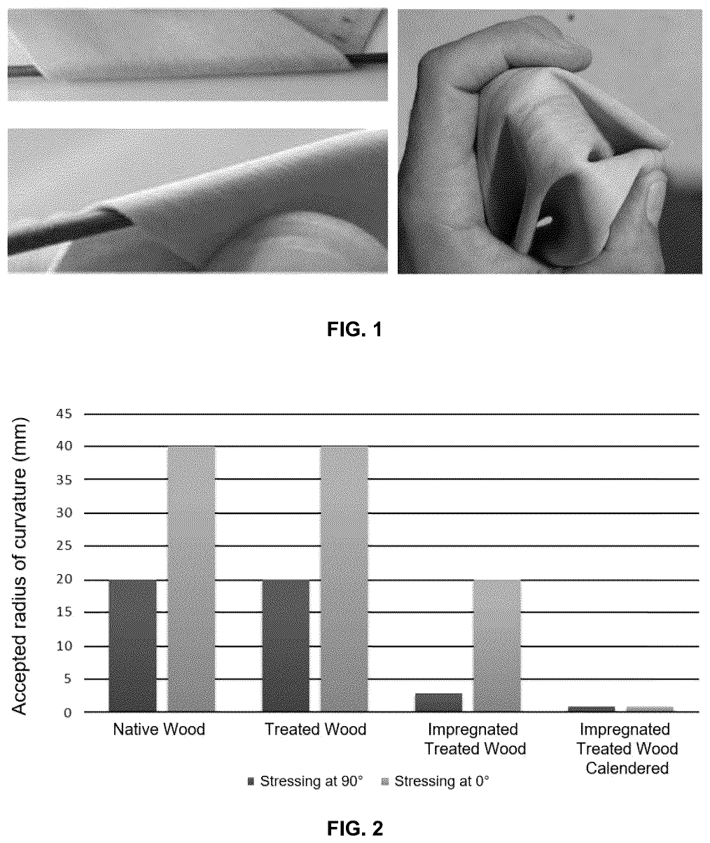

FIG. 1: Photographs of the material obtained. This figure shows the biaxial flexibility (hyperbolic paraboloid surfaces-longitudinal flexibility) of the material obtained at the end of the mechanical treatment step of the method of example 1.

FIG. 2: Diagram presenting the tangential radius of curvature of the material obtained after each step of the method of example 1 compared with the initial material used.

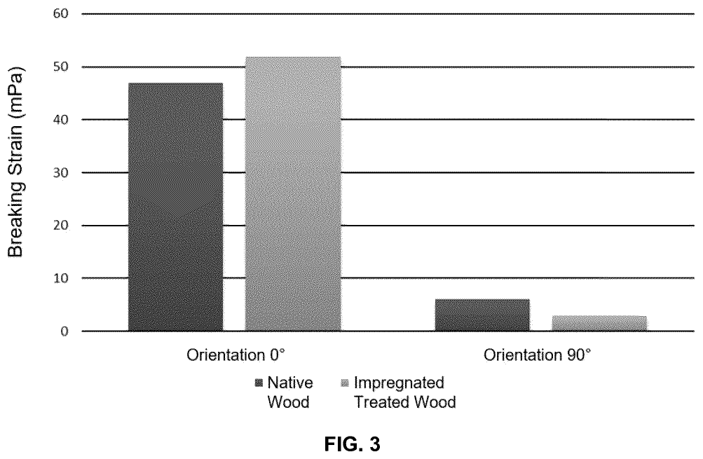

FIG. 3: Diagram presenting the mechanical properties under traction of the material obtained at the end of the impregnation step of example 1 compared with the initial material used.

### EXAMPLES

### Example 1

### Step 1: Chemical Treatment

In a glass reactor, a mass of 45 g of sodium hydroxide is dissolved in 450 g of temperate distilled water at 5° C. under stirring. After the sodium hydroxide is dissolved, a mass of 5 g of urea is dissolved in the solution. The solution obtained has a mass composition of 9% sodium hydroxide, 1% urea and 90% water.

The temperature of the solution is raised to 10° C.

A sheet of sycamore maple veneer of dimensions 150×150×0.6 mm is introduced into the reactor containing the solution. The treatment is thus implemented for a period of 6 hours at a temperature of 10° C.

The sheet of sycamore maple is next extracted from this medium to be placed in a bath of distilled water at 35° C. for 30 minutes. This operation is repeated 3 times in order to obtain a neutral pH.

### Step 2: Impregnation

The sheet of chemically treated wood is next immersed in a 50% solution of polyethylene glycol 400 for 72 hours at 25° C. The sheet is next extracted from this bath and then dried at 103° C. for 24 hours and then at 25° C. for 1 week.

### Step 3: Mechanical Treatment

The sheet of impregnated wood is next introduced into a belt press composed of 10 rollers 25 cm in diameter with a pressure of 5 bar. The sheet of wood thus obtained has biaxial flexibility and can be deformed repeatedly without the sheet being broken.

The radius of curvature was measured by rods with degressive diameters on rectangular test pieces of 100 mm by 50 mm.

The breaking strain was measured by a traction machine (Testometric X350) in accordance with the ISO 527 method.

The characteristics of the material obtained are presented in table 1 and in FIG. 1 to FIG. 3.

TABLE 1

| | Orientation at 0° | | | | Orientation at 90° | | |
|---|---|---|---|---|---|---|---|
| | Initial | | Modified | | Initial | | Modified |
| Property | wood | | wood | | wood | | wood |
| Radius of curvature | 40 | mm | 5 | mm | 5 | mm | Foldable in |
| without rupture of | | | | | | | two without |
| fibres | | | | | | | rupture of |
| | | | | | | | fibres |
| Rupture stress | 47 | MPa | 52 | MPa | 6 | MPa | 3 MPa |

1.-12. (canceled)

13. A method for preparing a lignocellulosic composite material, comprising:
(a) impregnating a lignocellulosic material with at least one filling compound; and
(b) subsequent to (a), applying a pressure to the lignocellulosic material impregnated with the at least one filling compound to generate the lignocellulosic composite material, wherein a tensile strength of the lignocellulosic composite material is greater than a tensile strength of the lignocellulosic material as measured by a traction machine using ISO 527.

14. The method of claim 13, wherein the pressure is at most about 20 bars.

15. The method of claim 13, wherein the tensile strength of the lignocellulosic composite material and the tensile strength of the lignocellulosic material are measured at a 0° orientation as measured by an angle with a longitudinal direction of a fiber of the lignocellulosic composite material or the lignocellulosic material.

16. The method of claim 13, wherein the tensile strength of the lignocellulosic composite material is more than 47 MPa.

17. The method of claim 13, wherein the tensile strength of the lignocellulosic composite material is at least about 10% greater than the tensile strength of the lignocellulosic material.

18. The method of claim 13, wherein (b) is performed at a temperature from −50° C. to about 250° C.

19. The method of claim 13, further comprising laminating the lignocellulosic composite material.

20. The method of claim 19, further comprising laminating two or more sheets of the lignocellulosic composite material.

21. The method of claim 13, wherein the at least one filling compound comprises polymers, prepolymers, monomers, compounds resulting from hydrolysis of oxyranic compounds, compounds derived from aziridine, compounds resulting from polymerisation of oxyranic compounds, polyols, carbohydrates, ionic liquids, deep eutectic solvents, natural polymers, synthetic polymers, carboxylic polyacids, derivatives thereof, or a combination thereof.

22. The method of claim 13, wherein the at least one filling compound comprises resins.

23. The method of claim 13, further comprising hydrating or dissolving cellulose or hemicellulose present within the lignocellulosic material.

24. The method of claim 13, further comprising delignifying the lignocellulosic material.

25. The method of claim 24, wherein from about 0.5% to 99%, be weight, of lignin present within the lignocellulosic material is removed.

26. The method of claim 13, further comprising
(a) impregnating or coating the lignocellulosic material or the lignocellulosic composite material;
(b) bleaching the lignocellulosic material;
(c) extracting extractables or chromophores from the lignocellulosic material;
(d) activating a hydroxyl group of the lignocellulosic material;
(e) substituting the hydroxyl group of the lignocellulosic material;
(f) oxidizing the lignocellulosic material;
(g) reducing of the lignocellulosic material;
(h) slitting the lignocellulosic material;
(i) washing the lignocellulosic material; or
(j) any combination thereof.

27. The method of claim 26, further comprising impregnating or coating the lignocellulosic material or the lignocellulosic composite material with an additive.

28. The method of claim 27, wherein the method comprises impregnating or coating the lignocellulosic material with the additive.

29. The method of claim 27, wherein the method comprises impregnating or coating the lignocellulosic composite material with the additive.

30. The method of claim 27, wherein the additive comprises fire-retarding agents, coloring agents, crosslinking agents, hydrophobic or waterproofing agents, surfactants, mixtures thereof, or any combinations thereof.

31. The method of claim 13, wherein the lignocellulosic material comprises a sheet, a plank, a plate, or a veneer of solid wood.

32. The method of claim 13, wherein an architecture of the lignocellulosic material is substantively preserved in the lignocellulosic composite material.
